(19) United States
(12) Patent Application Publication
(10) Pub. No.: US 2012/0102522 A1
(43) Pub. Date: Apr. 26, 2012

(54) EMERGENCY NOTIFICATION SYSTEM AND METHOD UTILIZING PREEMPTION OF ACTIVE MEDIA SESSIONS

(76) Inventors: Emmett Long, Dallas, TX (US); Michael Coyne, Dallas, TX (US); Rahul Vinekar, Plano, TX (US); Solomon Israel, Dallas, TX (US)

(21) Appl. No.: 12/912,402

(22) Filed: Oct. 26, 2010

(51) Int. Cl. H04N 7/10

(52) U.S. Cl. 725/33

(57) ABSTRACT

A Media Proxy, method, and Emergency Notification Service (ENS) system for providing emergency media content during an emergency to end-user devices currently engaged in active media sessions in a service provider's wireless or wireline network. The Media Proxy interrupts all currently active media sessions of all users located in the geographic area of an active emergency and inserts relevant emergency data such as detailed broadcast video or audio alerts by replacing the media in the currently active session with the emergency data.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND

The present invention relates to communication systems. More particularly, and not by way of limitation, the present invention is directed to an emergency notification system and method utilizing preemption of currently active media sessions.

Many types of emergency situations, such as natural and man-made public disasters and catastrophes may expose the general public within a particular geographic area to the risk of harm. Such emergency situations can impact large geographic areas and/or densely populated areas such that a great many individuals are placed at risk of being adversely affected by the emergency situation. Providing members of the public who are at risk with a timely warning of an emergency situation is important for saving lives and property.

Existing solutions for emergency notification systems have focused on different ways to disseminate emergency information to the general public. For example, some utilize radio and television broadcasts, cellular telephone Point-To-Multi-Point (P2MP) broadcasts, or cellular broadcasts to specially programmed personal warning devices. Other solutions work in reverse and enable members of the public to transmit notifications of emergency events to a central server for transmittal to the appropriate governmental agencies.

In addition, several standards bodies and regulatory commissions are actively working on methods to enhance the capabilities of emergency service personnel. These bodies and commissions include but are not limited to:
Cellular Emergency Advisory Systems Association (CEASA);
Internet Engineering Task Force (IETF) Geographic location/Privacy GEOPRIV) and Emergency Context Resolution with Internet Technologies (ECRIT);
Digital Subscriber Line (DSL) Forum;
Institute of Electrical and Electronic Engineers (IEEE): 802.1, 1A; Link Layer Discovery Protocol-Media Endpoint Discovery (LLDP MED), 802.11k, 802.11u);
Third Generation Partnership Project (3GPP) and 3GPP2;
European Telecommunications Standards Institute (ETSI) Emergency

Telecommunications (EMTEL) and Telecommunications and Internet converged services and Protocols for Advanced Networking (TISPAN);
PacketCable
International Telecommunications Union-Telecommunications (ITU-T) Study Group (SG) 13, SG 11, and SG 2;
Alliance for Telecommunications Industry Solutions Emergency Services Interconnection Forum (ATIS-ESIF);
WiMax Forum;
Open Mobile Alliance (OMA);
Organization for the Advancement of Structured Information. Standards (OASIS) Emergency Management Technical Committee (EM-TC) Group;
American National Standards Institute (ANSI) Homeland Security Standards Panel; and
Federal Communications Commission (FCC).

Existing emergency notification systems have numerous disadvantages, especially in the context of public use where many individuals must be warned of an emergency situation. Radio and television broadcasting systems cannot be entirely relied on to provide members of the public with emergency warnings because such systems may be rendered inoperable as a result of the emergency situation and/or because individuals may not be listening to a radio or watching a television at the very time that the emergency warning is broadcast. Accordingly, emergency warnings broadcast via radio and/or television may not reach a large segment of the population for whom the emergency warnings are intended or may not reach individuals until it is too late for them to take protective action.

Emergency notification systems utilizing cellular network technology focus on cellular broadcast capabilities and rely on the capabilities of standard handsets or specially designed handsets to alert the user. However, some mobile devices will not immediately display emergency broadcast messages and hence the messages are left in the users inbox for later retrieval. Other solutions require specific emergency devices tuned to specific frequencies or require specific action by end users. There are also solutions which provide the capability to seize cellular channels and resource from non-emergency users for use by emergency services personnel, primarily by providing the emergency personnel with a higher priority level. These systems provide emergency personnel with the ability to communicate among themselves, but not the ability to broadcast emergency information to the general public.

Use of the Internet to deliver emergency warnings has drawbacks similar to those of radio and television broadcasting. Just as people may not be watching television or listening to the radio, they may not be using a computer connected to the Internet.

### BRIEF SUMMARY OF THE INVENTION

In one embodiment of the present invention, a Media Proxy interrupts all currently active media sessions of all users currently located in the geographic area of an active emergency and inserts relevant emergency data such as detailed broadcast video or audio alerts by replacing the media in the currently active session with the emergency data. These media sessions may include video and audio sessions being conducted over the Internet, landline telecommunication networks, or wireless telecommunication networks.

In one embodiment, the present invention is directed to a media proxy for disseminating emergency media content during an emergency to end-user devices currently engaged in active media sessions in a service providers network. The media proxy receives media feeds from media content sources and provides active media feeds to respective end-user devices. The media proxy includes means for receiving an emergency notification from an emergency notification server; and means, responsive to the emergency notification, for interrupting the active media feeds and causing emergency media content to be disseminated to the end-user devices.

In another embodiment, the present invention is directed to a method of disseminating emergency media content during an emergency to end-user devices currently engaged in active media sessions in a service providers network. The end-user devices receive active media feeds from media content sources via a media proxy. The method includes the steps of receiving in the media proxy, an emergency notification from an emergency notification server; and in response to the emergency notification, interrupting the active media feeds by the media proxy; and causing emergency media content to be disseminated to the end-user devices.

In another embodiment, the present invention is directed to an Emergency Notification Service (ENS) system for disseminating emergency media content during an emergency to end-user devices currently engaged in active media sessions in a service provider's network. The ENS system includes an ENS Server for outputting an emergency notification; and a media proxy that receives media feeds from media content sources and provides active media feeds to respective end-user devices. The media proxy includes means for receiving the emergency notification from the ENS Server; and means, responsive to the emergency notification, for interrupting the active media feeds and causing emergency media content to be disseminated to the end-user devices.

There is no known solution today that preempts current active media sessions and substitutes emergency media feeds for end-user devices connected via both wireless and landline telephone networks. The present invention provides such a solution.

Advantageously, the present invention is not dependent on specific communications technologies, specific emergency devices, or specific device capabilities such as immediate emergency message display. The invention commandeers currently active data sessions, thus leading to a much higher probability of alerting the user of an emergency. Only the sessions of the users in the identified target region receive the new emergency media content. The invention is not limited to cellular networks and can be used to intercept any IP media feeds to devices such as mobile phones and laptops.

Additionally, it should be noted that the present invention does not interfere with, preempt, or otherwise impact other emergency methodologies such as radio and television message broadcasting or voice or data channel seizure.

### BRIEF DESCRIPTION OF THE SEVERAL VIEWS OF THE DRAWING

In the following section, the invention will be described with reference to exemplary embodiments illustrated in the figures, in which:

FIG. 1 is a simplified block diagram of a first exemplary embodiment of an Emergency Notification Service (ENS) system of the present invention;

FIG. 2 is a simplified block diagram of a second exemplary embodiment of the ENS system of the present invention;

FIG. 3 is a flow chart illustrating the steps of an exemplary embodiment of the method of the present invention; and

FIG. 4 is a simplified block diagram of a Media Proxy in an exemplary embodiment of the present invention.

### DETAILED DESCRIPTION OF THE INVENTION

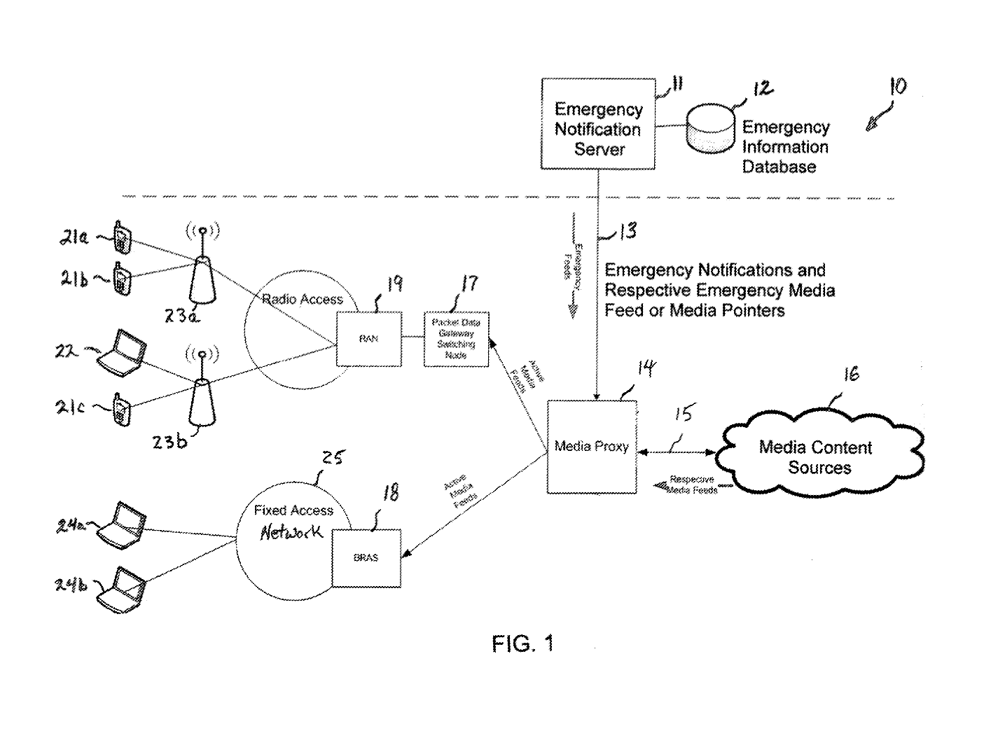

FIG. 1 is a simplified block diagram of a first exemplary embodiment of the Emergency Notification Service (ENS) system 10 of the present invention. In the event of an emergency, an ENS Server 11 obtains emergency information from a database 12 or other source, and includes the information in an ENS notification 13 sent to a Media Proxy 14. The emergency information may include, for example, an indication of the type of emergency, the geographic area affected by the emergency, and recommended actions to be taken by the recipient of the information. The ENS notification may also include a link to a live media feed, a media file for distribution, or metadata describing what kind of existing media should be disseminated. The Media Proxy is in the path of one or more media feeds 15 being transported from one or more media content sources 16 to various types of media gateways such as, for example, a Packet Data Gateway Switching Node (PDSN) 17 and a Broadband Remote Access Server (BRAS) 18. The PDSN 17, which may be, for example, a Gateway GPRS Service Node (GGSN) in a cellular core network connects to a Radio Access Network (RAN) 19, which provides end-user devices 21a-21c and 22 with access to the core network through radio base stations (RBSs)/Node Bs (or wireless access points) 23a-23b. The BRAS 18 may provide user terminals 24a-24b with fixed access through, for example, an Ethernet Local Area Network (LAN) or other fixed access network 25.

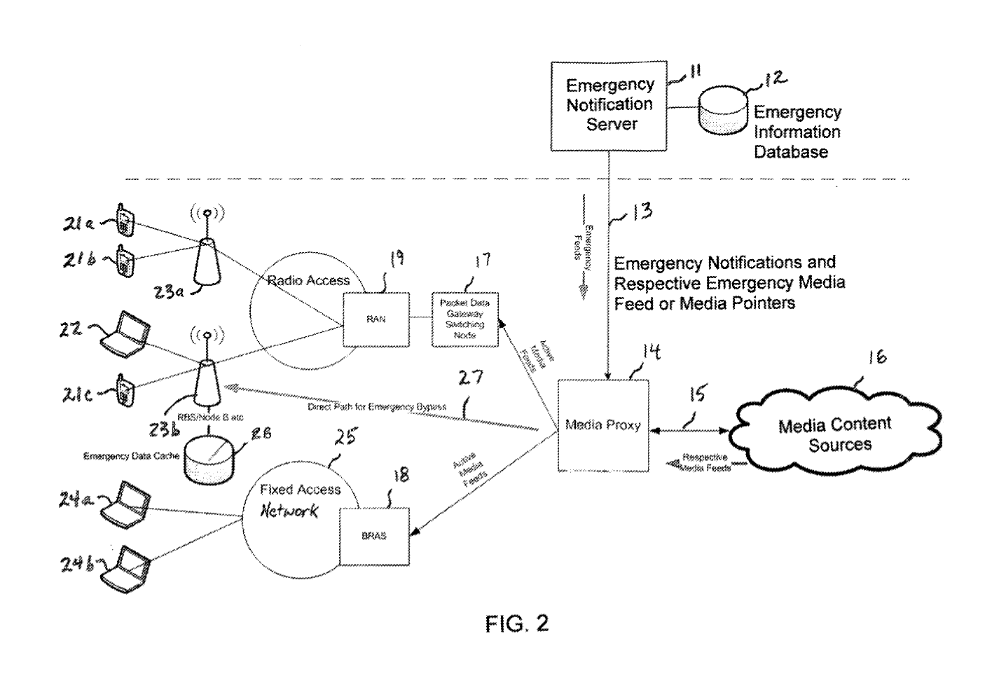

FIG. 2 is a simplified block diagram of a second exemplary embodiment of the ENS system of the present invention. In this embodiment, a logical direct connection 26 is provided between the Media Proxy 14 and one or more of the radio base stations 23a-23b. The same physical signaling path is utilized, but when the Media Proxy receives the ENS notification 13 from the ENS Server 11, the Media Proxy sends an emergency priority indicator in a message to the RBS/Node B. The RBS/Node B includes an emergency data cache 28 for storing ENS media, which the RBS/Node B selects based on the emergency indicator, and plays to the user terminals when the emergency indicator is received. Thus, a faster connection is provided since all that is needed from the Media Proxy is emergency signaling; no media transport is required. Additionally, the Media Proxy may also notify the RAN that the QoS for the session should be set to emergency and thus not be preempted by other QoS settings for RAN resource allocation. The RBS/Node B may implement the emergency QoS setting as defined, for example, in the Long Term Evolution (LTE) standards. In this way, the Media Proxy not only replaces existing sessions with emergency streams, but also takes steps to prevent preemption of the emergency media content.

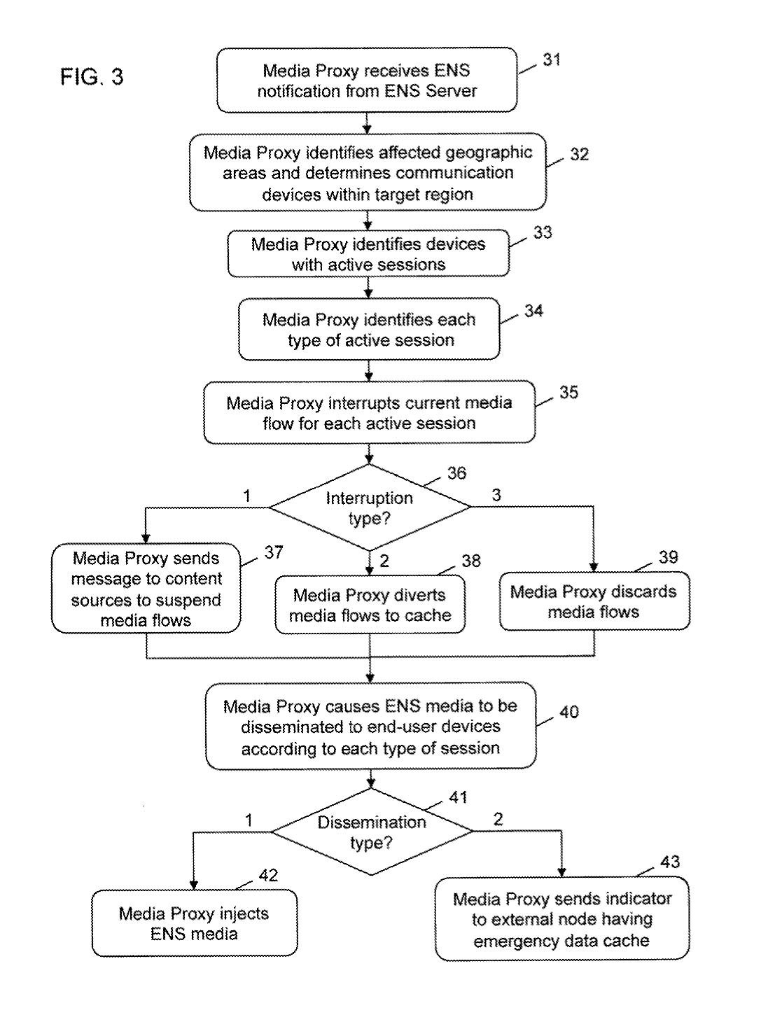

FIG. 3 is a flow chart illustrating the steps of an exemplary embodiment of the method of the present invention. At step 31, the Media Proxy 14 receives the ENS notification 13 from the ENS Server 11. At step 32, the Media Proxy identifies the affected geographic areas and determines the end-user devices known to be located within the target region. At step 33, the Media Proxy then identifies which of those end-user devices are currently engaged in active media sessions. At step 34, the Media Proxy then identifies each type of active media session. Once the active sessions and session types are identified, the method moves to step 35 where the Media Proxy interrupts the current media flow for each active session. The sessions may be interrupted in different ways, so at step 36, it is determined for example whether the Media Proxy will use interruption type 1, 2, or 3. If type 1 is used, the method moves to step 37 where the Media Proxy sends a message to the media content sources 16 to suspend the active media flows during the emergency notification. If type 2 is used, the method moves to step 38. The sessions between the media content sources 16 and the Media Proxy are maintained, but the Media Proxy diverts the active media flows during the emergency notification into a session buffer/cache for storage and retrieval after the emergency notification is completed. In this scenario, the session can continue after the emergency notification at the point the session was interrupted. If type 3 is used, the method moves to step 39. Again, the sessions between the media content sources and the Media Proxy are maintained, but the Media Proxy discards the media flows during the emergency notification. In this scenario, the media content during the emergency notification is lost, and the session continues at the point the emergency notification is completed.

At step 40, the Media Proxy causes the ENS media to be disseminated to the end-user devices. The dissemination may be performed in different ways, so at step 41, it is determined for example whether the Media Proxy will use dissemination type 1 or 2. If type 1 is used, the method moves to step 42 where the Media Proxy injects ENS media according to the type of session in place of the regular media flow, as shown in FIG. 1. If type 2 is used, the method moves to step 43 where the Media Proxy sends an emergency priority indicator to an external node such as the RBS/Node B, as shown in FIG. 2. The RBS/Node B then retrieves ENS media stored in the RBS/Node B emergency data cache 28 and substitutes the ENS media for the regular media flow.

In an alternative embodiment, the ENS notification 13 may point the Media Proxy 14 to an emergency content source where the ENS media can be found rather than carrying the ENS media in the notification. For example, the notification may include a link to a live media feed originating at the ENS Server 11 or other source. Likewise, as described in more detail below, the Media Proxy may include a database of prerecorded ENS media (ENS Notification Cache 53), and the ENS notification may simply provide a type identifier indicating which ENS media to retrieve and disseminate to the end-user devices. Regardless of the source, the Media Proxy preempts the active media streams with a new stream from the Media Proxy as specified in the emergency notification directive.

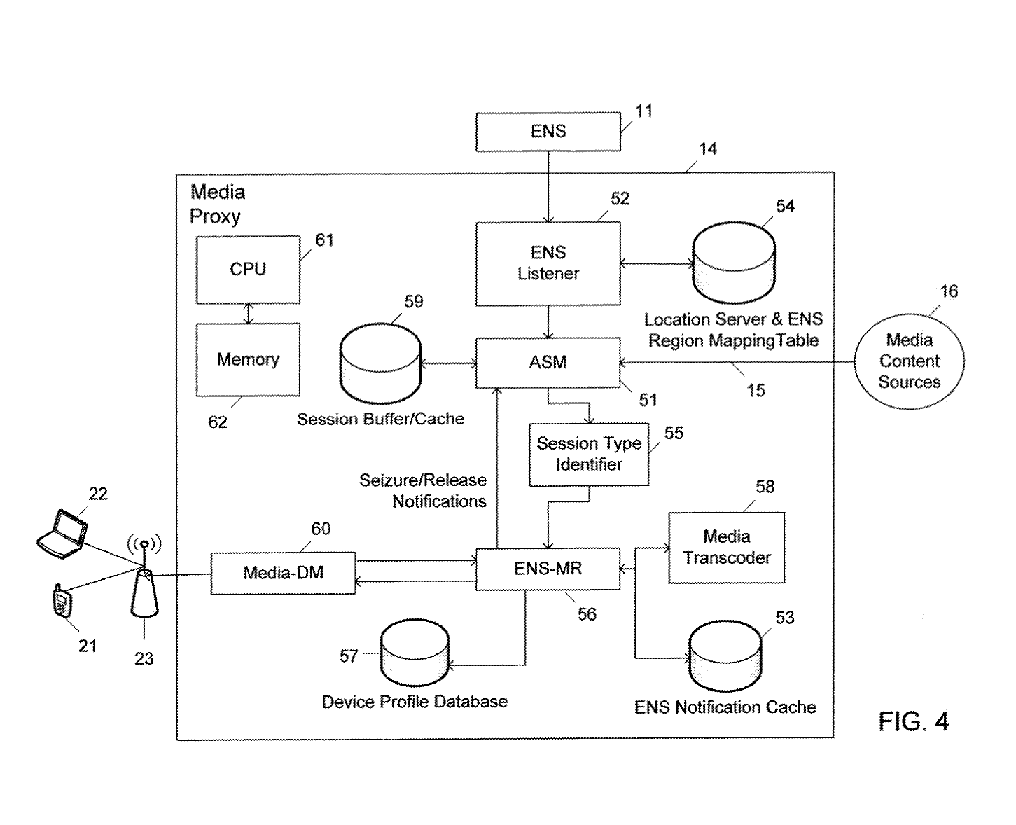

FIG. 4 is a simplified block diagram of the Media Proxy 14 in an exemplary embodiment of the present invention. In the embodiment shown, an operator is providing media sessions between external content sources 16 and end users 21-22 via the Media Proxy, which may be transparent or addressable. The Media Proxy includes an Active Session Manager (ASM) 51 for receiving the media feeds 15, and an ENS Listener 52 for receiving the ENS notification 13 from the ENS Server 11. The ENS Notification contains an ENS location identifier for the target location(s) of the emergency, and either the Emergency Notification Media or an Emergency Notification type identifier for cases where the notification has been preloaded in the Media Proxy's ENS Notification Cache (ENS-NC) 53. The ENS Listener may identify the target location(s) by accessing a location server and ENS region mapping table 54 and mapping the ENS location identifiers to location ID's used within the service providers network.

The ENS listener then sends the ENS notification and target location ID's to the ASM 51. The ASM sends a device User Agent and all application active session IDs to a Session Type Identifier 55 to determine which sessions are media sessions to which ENS notifications apply. This can be determined through a combination of subscriber Class of Service (CoS) settings and/or session protocol types. The Session Type Identifier sends the ENS media or ENS media identifier to an ENS Media Router (ENS-MR) 56. The ENS-MR determines whether the ENS media is contained within the ENS Notification sent from the Session Type Identifier or whether the ENS media needs to be retrieved from the local ENS Notification Cache (ENS-NC) 53 using the Emergency Notification type identifier sent in the original ENS notification 13 from the external ENS Server 11. If the ENS media needs to be retrieved, the ENS-MR requests the ENS media from the ENS-NC using the Emergency Notification type identifier. The ENS-NC receives the media request from the ENS-MR, identifies the correct ENS media file using the supplied Emergency Notification type identifier, and returns the ENS media file to the ENS-MR.

The ENS-MR 56 identifies the capabilities of all end-user devices in all currently actives sessions previously determined by the ASM 51. The ENS-MR uses the device User Agent supplied by the ASM and checks the capabilities against a Device Profile Database 57. Based on the target device capabilities and the ENS file format to be delivered, the ENS-MR determines whether the ENS media needs to be transcoded to ensure the target devices are capable of rendering the ENS media upon delivery. If transcoding is required, the ENS-MR invokes a Media Transcoder 58 with a target file format request. The Media Transcoder then transcodes the ENS media to the target format and returns the ENS media to the ENS-MR.

The ENS-MR 56 notifies the ASM 51 that the ENS-MR is going to seize existing sessions for the purpose of emergency notification delivery. The ENS-MR sends all relevant active session ID's to the ASM. The ASM may (1) send a message to the media content sources to suspend the current active sessions with the content sources during the emergency notification; (2) continue the current active session and discard the regular media content during the emergency notification; or (3) continue the current active session and buffer/cache the regular content in a Session Buffer/Cache 59. The action of the ASM is determined based on session type, source media caching directives, and Media Proxy caching capabilities.

The ENS-MR 56 sends the ENS Media with the destination addresses for the end-user devices to a Media Delivery Mechanism (Media-DM) 60. The Media-DM delivers the emergency media to all target devices via the appropriate network channels. As each emergency notification session ends, the Media-DM notifies the ENS-MR 56 that each respective emergency session is complete. The ENS-MR notifies the ASM 51 that the respective emergency sessions are now complete. The ASM either resumes the previous media session (if the session was buffered) or the ASM terminates all user and media source connections and marks the user session state to IDLE.

The operation of the Media Proxy 14 may be controlled by a central processing unit (CPU) 61 executing computer program instructions stored on a memory 62. Alternatively, the Media Proxy may be implemented in hardware, firmware, or a combination of software, hardware, and firmware.

Traffic such as over-the-top (OTT) TV from online video services like Hulu.com may also flow through the Media Proxy. Such traffic is protected by a Digital Rights Management (DRM) license, but the Media Proxy still knows what the traffic is and can still interrupt the session and disseminate the ENS media to the OTT TV viewers. Alternatively, a dedicated Media Proxy may be integrated with the website of an online video service utilizing, for example, an ENS Application Programming Interface (API) or similar integration technique to enable the network to preempt these premium protected media feeds during an emergency.

As described above in various embodiments, the present invention provides a Media Proxy, system, and method for preempting current active media sessions and substituting emergency media feeds for end-user devices connected via both wireless and landline telephone networks. The invention is not dependent on specific communications technologies, specific emergency devices, or specific device capabilities.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A media proxy for disseminating emergency media content during an emergency to end-user devices currently engaged in active media sessions in a service provider's network, wherein the media proxy receives media feeds from media content sources and provides active media feeds to respective end-user devices, the media proxy comprising:
means for receiving an emergency notification from an emergency notification server;
means, responsive to the emergency notification, for interrupting the active media feeds; and
means for causing emergency media content to be disseminated to the end-user devices.

2. The media proxy according to claim 1, further comprising an emergency media notification cache for storing the emergency media content prior to the emergency, wherein the emergency notification includes an emergency notification type identifier for identifying specific emergency media content in the emergency media notification cache for disseminating to the end-user devices.

3. The media proxy according to claim 1, wherein the emergency notification includes the emergency media content and a location identifier for a target region of the emergency, wherein the media proxy further comprises:
a location mapping table for mapping the location identifier received in the emergency notification to a second location identifier utilized in the service provider's network; and
means for identifying end-user devices engaged in active media sessions in the target region of the emergency, wherein the media proxy interrupts the active media feeds and causes emergency media content to be disseminated only to the end-user devices in the target region.

4. The media proxy according to claim 1, further comprising:
a session type identifier for identifying the type of active media session in which each end-user device is currently engaged; and,
a media transcoder for transcoding the emergency media content for each end-user device according to the session type for each end-user device.

5. The media proxy according to claim 1, wherein the means for interrupting the active media feeds includes means for sending a message to the media content sources to suspend the media feeds during the emergency notification.

6. The media proxy according to claim 1, wherein the means for interrupting the active media feeds includes means for diverting the active media feeds into a session buffer/cache for storage and retrieval after the emergency notification.

7. The media proxy according to claim 1, wherein the means for interrupting the active media feeds includes means for discarding the active media feeds during the emergency notification.

8. The media proxy according to claim 1, wherein the emergency media content is stored in an emergency data cache in an access network node, and the emergency notification received by the media proxy includes an emergency notification type identifier for identifying specific media content in the access network node's emergency data cache for providing to the end-user devices;
wherein the means for causing emergency media content to be disseminated to the end-user devices includes means for sending the emergency notification type identifier to the access network node.

9. The media proxy according to claim 8, wherein the means for causing emergency media content to be disseminated to the end-user devices also includes means for notifying the access network node that the Quality of Service (QoS) for the session should be set to an emergency level to preclude preemption by other QoS settings for access network resource allocation.

10. A method of disseminating emergency media content during an emergency to end-user devices currently engaged in active media sessions in a service provider's network, wherein the end-user devices receive active media feeds from media content sources via a media proxy, the method comprising the steps of:
receiving in the media proxy, an emergency notification from an emergency notification server; and
in response to the emergency notification:
interrupting the active media feeds by the media proxy; and
causing emergency media content to be disseminated to the end-user devices.

11. The method according to claim 10, further comprising storing the emergency media content prior to the emergency in an emergency media notification cache in the media proxy;
wherein the emergency notification includes an emergency notification type identifier and the step of causing emergency media content to be disseminated to the end-user devices includes:
utilizing the emergency notification type identifier by the media proxy to identify specific media content in the emergency media notification cache; and
sending the identified specific media content from the media proxy to the end-user devices.

12. The method according to claim 10, wherein the emergency notification includes the emergency media content and a location identifier for a target region of the emergency, and the method further comprises identifying end-user devices engaged in active media sessions in the target region of the emergency;
wherein the step of interrupting the active media feeds by the media proxy includes interrupting the active media feeds of only the end-user devices in the target region; and
wherein the step of causing emergency media content to be disseminated to the end-user devices includes sending the emergency media content from the media proxy only to end-user devices operating in the target region.

13. The method according to claim 12, further comprising the steps of:
identifying by the media proxy, a type of active media session in which each end-user device is currently engaged; and
transcoding by the media proxy, the emergency media content for each end-user device according to the session type for each end-user device.

14. The method according to claim 10, wherein the step of interrupting the active media feeds includes sending a message from the media proxy to the media content sources to suspend the media feeds during the emergency notification.

15. The method according to claim 10, wherein the step of interrupting the active media feeds includes the media proxy diverting the active media feeds into a session buffer/cache for storage and retrieval after the emergency notification.

16. The method according to claim 10, wherein the step of interrupting the active media feeds includes the media proxy discarding the active media feeds during the emergency notification.

17. The method according to claim 10, wherein the emergency media content is stored in an emergency data cache in an access network node, and the emergency notification received by the media proxy includes an emergency notification type identifier for identifying specific media content in the access network node's emergency data cache for providing to the end-user devices;
wherein the step of causing emergency media content to be disseminated to the end-user devices includes sending the emergency notification type identifier from the media proxy to the access network node.

18. The method according to claim 17, wherein the step of causing emergency media content to be disseminated to the end-user devices also includes notifying the access network node that the Quality of Service (QoS) for the session should be set to an emergency level to preclude preemption by other QoS settings for access network resource allocation.

19. An Emergency Notification Service (ENS) system for disseminating emergency media content during an emergency to end-user devices currently engaged in active media sessions in a service provider's network, the ENS system comprising:
an ENS Server for outputting an emergency notification;
a media proxy that receives media feeds from media content sources and provides active media feeds to respective end-user devices, the media proxy comprising:
means for receiving the emergency notification from the ENS Server;
means, responsive to the emergency notification, for interrupting the active media feeds; and
means for causing emergency media content to be disseminated to the end-user devices.

20. The ENS system according to claim 19, further comprising an emergency information database in communication with the ENS Server, the emergency information database providing to the ENS Server, the emergency media content or links to the emergency media content.

21. The ENS system according to claim 19, wherein the media proxy also includes an emergency media notification cache for storing the emergency media content prior to the emergency, wherein the emergency notification includes an emergency notification type identifier for identifying specific media content in the emergency media notification cache for disseminating to the end-user devices.

22. The ENS system according to claim 19, wherein the means for interrupting the active media feeds is selected from a group consisting of:
means for sending a message to the media content sources to suspend the media feeds during the emergency notification;
means for diverting the active media feeds into a session buffer/cache for storage and retrieval after the emergency notification; and
means for discarding the active media feeds during the emergency notification.

23. The ENS system according to claim 19, further comprising an access network node having an emergency data cache for storing the emergency media content;
wherein the emergency notification received by the media proxy includes an emergency notification type identifier for identifying specific media content in the access network node's emergency data cache for disseminating to the end-user devices; and
wherein the means for causing emergency media content to be disseminated to the end-user devices includes means for sending the emergency notification type identifier to the access network node.

24. The ENS system according to claim 23, wherein the means for causing emergency media content to be disseminated to the end-user devices also includes means for notifying the access network node that the Quality of Service (QoS) for the session should be set to an emergency level to preclude preemption by other QoS settings for access network resource allocation.
